(19) United States
(12) Patent Application Publication
(10) Pub. No.: US 2024/0258707 A1
(43) Pub. Date: Aug. 1, 2024

(54) MODULATED METASURFACE ANTENNA AND DESIGN

(71) Applicant: UNIVERSITE CATHOLIQUE DE LOUVAIN, Louvain-laNeuve (BE)

(72) Inventors: Modeste BODEHOU, Louvain-la-Neuve (BE); Christophe CRAEYE, Louvain-la-Neuve (BE)

(21) Appl. No.: 18/289,717

(22) PCT Filed: May 9, 2022
(86) PCT No.: PCT/EP2022/062521

§ 371 Date: Nov. 6, 2023

(30) Foreign Application Priority Data
May 7, 2021 (EP) 21172720.1

(51) Int. Cl. H01Q 15/00; H01Q 3/26; H01Q 13/28

(52) U.S. Cl. CPC H01Q 15/0086; H01Q 3/26; H01Q 13/28

(57) ABSTRACT

In a modulated metasurface antenna, a surface wave transducer generates a surface wave when a radio-frequency excitation signal is applied to the surface wave transducer. The surface wave propagates throughout a surface wave propagation medium from the surface wave transducer to a rim of the surface wave propagation medium. The surface wave propagation medium has an electromagnetic surface impedance distribution that exhibits impedance variations that extend from the surface wave transducer to the rim of the surface wave propagation medium. The electromagnetic surface impedance distribution is non-uniform in azimuth direction on the surface wave propagation medium. The surface wave transducer has a non-uniform azimuthal surface wave power distribution so that, compared to a uniform azimuthal surface wave power distribution, a smaller amount of surface wave power is launched in the azimuth ranges where the impedance variations are the smallest.

### CROSS-REFERENCE TO RELATED APPLICATION(S)

This is a National Stage Entry into the United States Patent and Trademark Office from International Patent Application No. PCT/EP2022/062521, filed on May 9, 2022, which relies on and claims priority to European Patent Application No. 21172720.1, filed on May 7, 2021, the entire contents of both of which are incorporated herein by reference.

### FIELD OF THE INVENTION

An aspect of the invention relates to a modulated metasurface antenna. The modulated metasurface antenna may be used, for example, in radar systems and communication systems. Further aspects of the invention relate to an antenna-based system and a method of designing a modulated metasurface antenna.

### BACKGROUND OF THE INVENTION

A modulated metasurface antenna typically comprises a surface wave transducer, which is commonly referred to as surface wave launcher, and a surface wave propagation medium. The surface wave transducer may be incorporated at a central location in the surface wave propagation medium. The surface wave transducer may comprise, for example, a pin that constitutes a monopole. The surface wave propagation medium may comprise, for example, a dielectric substrate having one side that is provided with a ground plane and another, opposite side that is provided with subwavelength-sized conductive elements.

From an electromagnetic point of view, the side of the surface wave propagation medium that is provided with subwavelength-sized conductive elements has an impedance distribution, which may be referred to as electromagnetic surface impedance distribution. The electromagnetic surface impedance distribution exhibits variations that extend from the surface wave transducer to a rim of the surface wave propagation medium. These impedance variations may result from, for example, the aforementioned subwavelength-sized conductive elements varying in density, or in size, or in shape, or in any combination of these.

In a transmission mode, a radiofrequency signal may excite the surface wave transducer, which then generates a surface wave. The surface wave propagates from the surface wave transducer through the surface wave propagation medium towards the rim of the surface wave propagation medium. The surface wave is, as it were, perturbed by the aforementioned impedance variations. The impedance variations cause leakage of the surface wave from the surface wave propagation medium. This leakage is also referred to as transformation of the surface wave into a leaky wave. The leakage constitutes a radiation from the surface wave propagation medium. The radiation has a distribution over the surface wave propagation medium that depends on the electromagnetic surface impedance distribution. Accordingly, a desired radiation pattern can be obtained with a specific electromagnetic surface impedance distribution over the surface wave propagation medium.

The article by M. Bodehou et al. entitled “A Quasi-Direct Method for the Surface Impedance Design of Modulated Metasurface Antennas” published IEEE Transactions on Antennas and Propagation, vol. 67, No. 1, January 2019, presents an approach for synthesizing modulated metasurface antennas with arbitrary radiation patterns, assumed to be given in amplitude, phase, and polarization. The metasurface is defined on a circular domain and is represented as a continuous sheet transition impedance boundary condition on the top of a grounded substrate. The proposed method relies on an entire-domain discretization of the electric field integral equation. Via the dyadic Green's function of the grounded substrate, the desired radiation pattern is translated into the visible part of the surface current spectrum, decomposed into entire-domain and orthogonal basis functions, while the invisible part of the spectrum stems from the solution of the unmodulated sheet problem. The electric field integral equation is then inverted to obtain the sheet impedance, which is constrained to be anti-Hermitian, as required for implementation with lossless patches. The aforementioned article will be referred to hereinafter as first-cited article for the sake of convenience.

### SUMMARY OF THE INVENTION

There is a need for an improved modulated metasurface antenna, as well as a design thereof, that allows achieving higher efficiency, in particular in terms of a power ratio between, on the one hand, (3D-shaped) radiation from the modulated metasurface antenna in desired angular ranges (azimuth and elevation) and, on the other hand, an excitation signal applied to the surface wave transducer.

In accordance with an aspect of the invention as defined in claim 1, there is provided a modulated metasurface antenna comprising a surface wave transducer and a surface wave propagation medium, the surface wave transducer being adapted generate a surface wave when a radio-frequency excitation signal is applied to the surface wave transducer, whereby the surface wave propagates throughout the surface wave propagation medium from the surface wave transducer to a rim of the surface wave propagation medium, the surface wave propagation medium having an electromagnetic surface impedance distribution that exhibits impedance variations that extend from the surface wave transducer to the rim of the surface wave propagation medium, the electromagnetic surface impedance distribution being non-uniform in azimuth direction on the surface wave propagation medium so that there are azimuth ranges in which the impedance variations are smallest from the surface wave transducer to the rim of the surface wave propagation medium, wherein the surface wave transducer has a non-uniform azimuthal surface wave power distribution so that, compared to a uniform azimuthal surface wave power distribution, a smallest amount of surface wave power is launched in the azimuth ranges where the impedance variations are the smallest.

In accordance with a further aspect of the invention as defined in claim 10, there is provided an antenna-based system comprising a modulated metasurface antenna as defined hereinbefore.

The invention takes the following aspects into consideration. A modulated metasurface antenna has an overall efficiency that is a joint result of several types of efficiencies, which include aperture efficiency and conversion efficiency. The aperture efficiency is related to a radiation pattern that the modulated metasurface antenna actually provides compared with a desired radiation pattern. Power should be radiated in a desired range of azimuth directions and a desired range of elevation directions. Power radiated in other directions may be considered a loss, which adversely affects aperture efficiency. The conversion efficiency is a power ratio between, on the one hand, the surface wave generated by the surface wave transducer, which propagates through the surface wave propagation medium, and, on the other hand, radiation from the surface wave propagation medium due to the leakage of the surface wave, as described hereinbefore. The conversion efficiency should be as high as possible to avoid undesired reflection and diffraction effects at the rim of the surface wave propagation medium.

In practice, the aforementioned two efficiencies, aperture efficiency and conversion efficiency, may be contradictory. This implies a compromise between the aperture efficiency and the conversion efficiency. In general, relatively small impedance variations throughout the surface wave propagation medium may be beneficial to the aperture efficiency, but may be detrimental to the conversion efficiency. Conversely, relatively large impedance variations may be beneficial to the conversion efficiency, but may be detrimental to the aperture efficiency. A basic approach may thus involve finding an amplitude for the impedance variations throughout the surface wave propagation medium that provides a satisfactory compromise. A more advanced approach may involve non-uniformity in amplitude of the impedance variations. The latter approach may provide satisfactory overall efficiency for specific radiation patterns, in particular a pencil shaped radiation patterns.

However, there is a wide variety of radiation patterns for which the aforementioned approaches may not provide satisfactory overall efficiency. For example, a 3D desired radiation pattern may be significantly wider in elevation direction than in azimuth direction, or vice versa. Such a radiation pattern translates into a 2D electromagnetic surface impedance distribution that is non-uniform in terms of magnitude of impedance variations versus azimuth direction. The electromagnetic surface impedance distribution may exhibit relatively large impedance variations certain azimuth ranges, whereas impedance variations in other azimuth ranges may be relatively small. The surface wave that propagates through the surface wave propagation medium will leak to produce radiation to a relatively large extent in an azimuth range where impedance variations are relatively large. Conversely, the surface wave will leak to a relatively small extent only in an azimuth range where impedance variations are relatively small. As a result, in the latter azimuth range, the surface wave will still be relatively strong, not much attenuated, when reaching the rim of the surface wave propagation medium. The surface wave will be diffracted and reflected at the rim, which is detrimental to the conversion efficiency.

In accordance with the invention, the surface wave transducer of the modulated metasurface antenna has a non-uniform azimuthal surface wave power distribution so that, compared to a uniform azimuthal surface wave power distribution, a smaller amount of surface wave power is launched in the azimuth ranges where the impedance variations are the smallest. Thus, a relatively large proportion of the surface wave power is launched in directions where the surface wave is leaked to produce radiation to a relatively great extent. Conversely, only a relatively small proportion of the surface wave power is launched in directions where the surface wave is not significantly leaked. Accordingly, a relatively high conversion efficiency can be achieved and, therefore, a relatively high overall efficiency of the modulated metasurface antenna.

In accordance with yet a further aspect of the invention as defined in claim 13, there is provided a method of designing a modulated metasurface antenna as defined hereinbefore, the method comprising:
elaborating an initial electromagnetic surface impedance distribution for the surface wave propagation medium that causes the modulated metasurface antenna to have a desired radiation pattern, on the basis of an initial surface wave transducer that launches a surface wave according to an initial azimuthal surface wave power distribution;
determining an azimuthal distribution of surface wave power arriving on the rim of the surface wave propagation medium; and
adapting the surface wave transducer on the basis of the azimuthal distribution of surface wave power arriving on the rim of the surface wave propagation medium, so as to obtain a more uniformly azimuthal distribution of surface wave power arriving on the rim of the surface wave propagation medium thereby increasing conversion efficiency of the modulated metasurface antenna.

For the purpose of illustration, some embodiments of the invention are described in detail with reference to accompanying drawings. In this description, additional features will be presented, some of which are defined in the dependent claims, and advantages will be apparent.

### BRIEF DESCRIPTION OF THE DRAWINGS

FIG. 1 is schematic perspective view diagram of a modulated metasurface antenna, which also schematically illustrates a radiation pattern of the modulated metasurface antenna.

FIG. 2 is a schematic top view diagram of the modulated metasurface antenna, which also indicates a portion thereof.

FIG. 3 is a schematic top view diagram of the portion of the modulated metasurface antenna indicated in FIG. 2, which constitutes a close up illustrating this portion in greater detail.

FIG. 4 is a schematic partial cross-sectional diagram of the modulated metasurface antenna, which includes graphical annotations for the sake of explanation of its operation.

FIG. 5 is a graph of a flat top beam radiation pattern produced by a modulated metasurface antenna.

FIG. 6 is a graph of an electromagnetic surface impedance distribution for a basic modulated metasurface antenna having the flat top beam radiation pattern.

FIG. 7 is a graph of an azimuthal distribution of surface wave power arriving at a rim of a surface wave propagation medium in the basic modulated metasurface antenna having the flat top beam radiation pattern.

FIG. 8 is schematic top view of an improved modulated metasurface antenna.

FIG. 9 is a graph of an azimuthal surface wave power distribution of a surface wave transducer in the improved modulated metasurface antenna.

FIG. 10 is a graph of a redesigned electromagnetic surface impedance distribution for the improved modulated metasurface antenna having the flat top beam radiation pattern.

FIG. 11 is a graph of an azimuthal distribution of surface wave power arriving at a rim of a surface wave propagation medium in the improved modulated metasurface antenna having the flat top beam radiation pattern.

FIG. 12 is a graph of a conical sectorial beam radiation pattern.

FIG. 13 is a graph of an electromagnetic surface impedance distribution for a basic modulated metasurface antenna having the conical sectorial beam radiation pattern.

FIG. 14 is a graph of an azimuthal distribution of surface wave power arriving at a rim of a surface wave propagation medium in the basic modulated metasurface antenna and in an improved modulated metasurface antenna, both having the conical sectorial beam radiation pattern.

FIG. 15 is a flow chart diagram of a method of designing a modulated metasurface antenna.

FIG. 16 is a schematic block diagram of an antenna-based system comprising a modulated metasurface antenna.

### DESCRIPTION OF EMBODIMENT(S) OF THE INVENTION

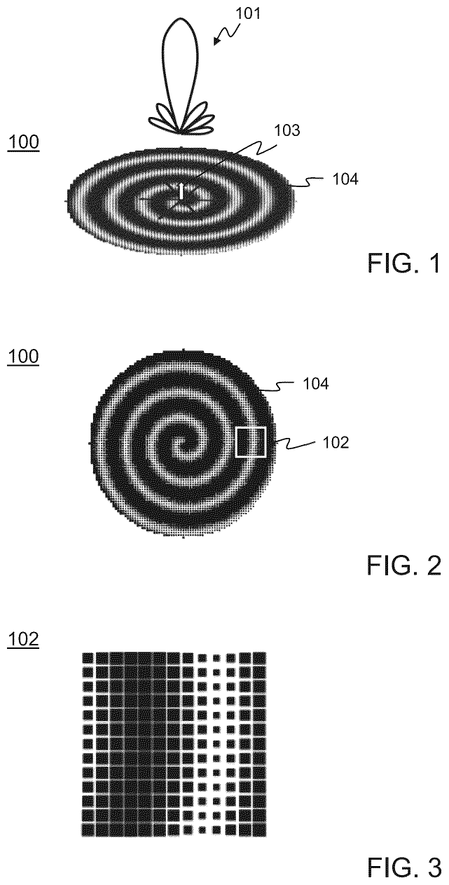

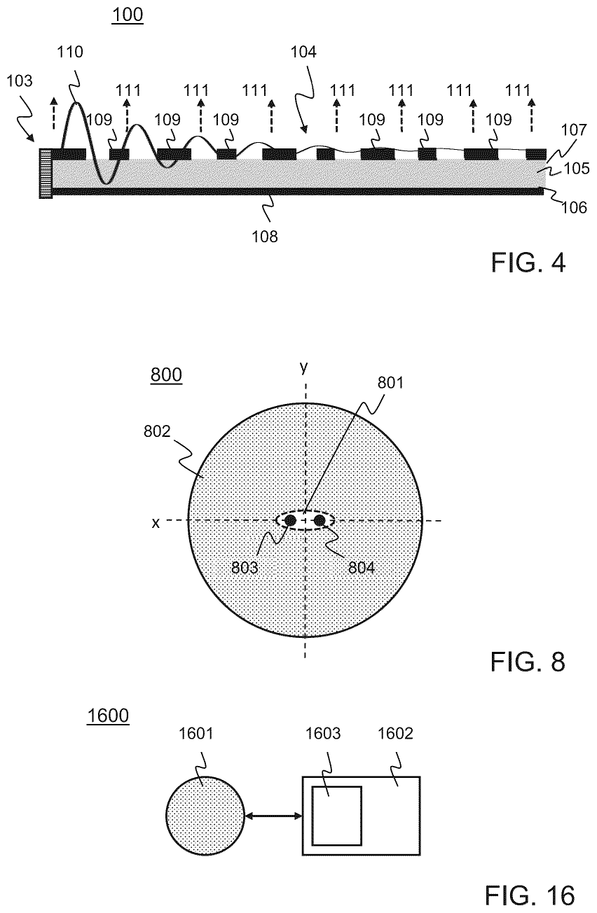

FIGS. 1, 2, 3 and 4 schematically illustrate a modulated metasurface antenna 100. FIG. 1 provides a schematic perspective view diagram of the modulated metasurface antenna 100, which also schematically illustrates a radiation pattern 101 of the modulated metasurface antenna 100. FIG. 2 provides a schematic top view diagram of the modulated metasurface antenna 100, which also indicates a portion 102 thereof. FIG. 3 provides a schematic top view diagram of the portion 102 of the modulated metasurface antenna 100 indicated in FIG. 2, which constitutes a close up illustrating the portion in greater detail. FIG. 4 provides a schematic partial cross-sectional diagram of the modulated metasurface antenna 100, which includes annotations for the sake of explanation of its operation.

The modulated metasurface antenna 100 comprises a surface wave transducer 103 and a surface wave propagation medium 104. The surface wave transducer 103 may be incorporated at a central location in the surface wave propagation medium 104. The surface wave transducer 103 may comprise, for example, a pin that constitutes a monopole, or a slot, or a waveguide, or a combination of these. In a transmitter system, the surface wave transducer 103 may be coupled to receive a radiofrequency excitation signal from an emitter device.

In this embodiment, the surface wave propagation medium 104 comprises a dielectric substrate 105 of circular shape. The dielectric substrate 105 has two sides 106, 107 one of which 106 is provided with a ground plane 108. The other, opposite side 107 of the dielectric substrate 105 is provided with a multitude of electrically conductive patches 109, which are sub-wavelength sized. The term sub-wavelength sized indicates that a largest dimension of a patch is about an order of magnitude shorter than a wavelength at which the modulated metasurface antenna 100 should operate.

As illustrated in FIG. 3, the electrically conductive patches are distributed over the dielectric substrate 105 in a manner whereby these vary in density, or in size, or in shape, or in any combination of these. The electrically conductive patches define an electromagnetic impedance distribution over the side of the dielectric substrate 105 where these patches are located. This electromagnetic impedance distribution will be referred to hereinafter as electromagnetic surface impedance distribution for the sake of convenience.

The electrically conductive patches may conceptually be associated with pixels or dots that form an image. Rather than defining brightness variations, as pixels do in an image, the electrically conductive patches define variations in the electromagnetic surface impedance distribution. Such an impedance variation typically covers a distance in the order of magnitude of the wavelength.

The modulated metasurface antenna 100 basically operates as follows. In a transmission mode, a radiofrequency signal excites the surface wave transducer 103, which then generates a surface wave 110 that has an equivalent surface current as illustrated in FIG. 4. The surface wave 110 propagates from the surface wave transducer 103 through the dielectric substrate 105 towards a rim of the dielectric substrate 105. The surface wave 110 is, as it were, perturbed by the variations in the electromagnetic surface impedance distribution. These electromagnetic surface impedance variations cause leakage of the surface wave from the dielectric substrate 105. This surface wave leakage is also referred to as transformation of the surface wave into a leaky wave. The surface wave leakage constitutes a radiation 111 from the dielectric substrate 105 at the side 107 wherein the electrically conductive patches 109 are present, as illustrated in FIG. 4. This side 107 will therefore be referred to hereinafter as radiating surface for the sake of convenience.

The electromagnetic surface impedance distribution defines a distribution of the surface wave leakage over the radiating surface of the modulated metasurface antenna 100. In turn, the distribution of surface wave leakage over the radiating surface defines a radiation pattern of the modulated metasurface antenna 100 concerned. Accordingly, a desired radiation pattern can be obtained by translating, as it were, the desired radiation pattern into a specific electromagnetic surface impedance distribution. The multitude of electrically conductive patches 109 may then be arranged such that the surface wave propagation medium 104 exhibits this specific electromagnetic surface impedance distribution.

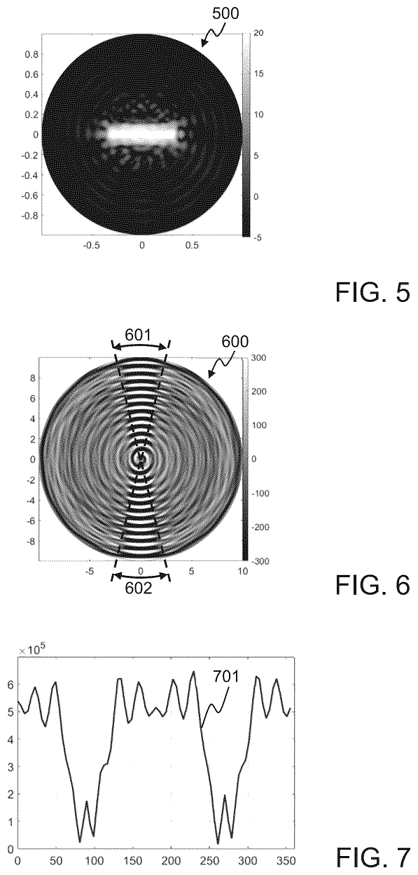

FIG. 5 schematically illustrates a flat top beam radiation pattern 500 produced by a modulated metasurface antenna. FIG. 5 is a graph that represents a plane parallel to the radiating surface of the modulated metasurface antenna. The graph indicates a radiated power distribution in the plane by means of gray levels. The lighter the gray level is at a point, the higher the power density that is radiated at that point. The flat top beam radiation pattern 500 is characterized by an elongated rectangular box in the plane. The flat top beam radiation pattern 500 is thus non-uniform in azimuth direction.

The flat top beam radiation pattern 500 illustrated in FIG. 5 may be produced by a basic modulated metasurface antenna, which may be similar to the modulated metasurface antenna 100 described hereinbefore with reference to FIGS. 1-4. In the basic modulated metasurface antenna, a monopole formed by a pin constitutes the surface wave transducer. Accordingly, the surface wave transducer has an azimuthal surface wave power distribution that is uniform, isotropic in azimuth direction. That is, surface wave power is isotopically launched into the surface wave propagation medium 104.

FIG. 6 schematically illustrates an electromagnetic surface impedance distribution 600 for the basic modulated metasurface antenna having the flat top beam radiation pattern 500. FIG. 6 is a graph that represents the radiating surface of the basic modulated metasurface antenna. The graph has a horizontal axis and a vertical axis that each indicate a distance from a center point on the radiating surface along the axis concerned. The distance is expressed units of wavelength. The graph indicates the electromagnetic surface impedance distribution 600 is by means of gray levels. Specifically, the graph indicates an electromagnetic surface reactance distribution by means of gray levels. A middle gray level represents zero reactance. The lighter the gray level is at a point with respect to the middle gray level, the higher the reactance is, whereby the reactance has a positive sign. Conversely, the darker the gray level is at a point with respect to the middle gray level, the higher the reactance is, whereby the reactance has a negative sign.

The electromagnetic surface impedance distribution 600 illustrated in FIG. 6 is non-uniform in azimuth direction on the surface wave propagation medium. The electromagnetic surface impedance distribution 600 exhibits relatively large variations in two relatively narrow azimuth ranges 601, 602. These two azimuth ranges 601, 602 in which relatively large electromagnetic surface impedance variations occur are substantially oriented along the vertical axis. Conversely, electromagnetic surface impedance variations are relatively small in two other, remaining azimuth ranges, which are relatively wide and substantially oriented along the horizontal axis.

FIG. 7 schematically illustrates an azimuthal distribution of surface wave power arriving at a rim of the surface wave propagation medium 104 in the basic modulated metasurface antenna having the flat top beam radiation pattern 500. FIG. 7 is a graph that has a horizontal axis representing angular positions on the rim in units of degrees. A vertical axis represents angular power density, the azimuthal distribution of surface wave power arriving at the rim in units of Watt per degree. A curve 701 in the graph represents the azimuthal distribution of surface wave power arriving at a rim.

As can be seen from FIG. 7, a relatively large proportion of surface wave power arrives at the rim over a relatively wide range of angles. All this surface wave power has not been leaked to produce radiation. Moreover, the surface power that arrives at the rim causes undesired reflection and diffraction. All this is detrimental to the conversion efficiency and, therefore, the overall efficiency of the modulated metasurface antenna.

FIG. 8 schematically illustrates an improved modulated metasurface antenna 800. FIG. 8 provides a schematic top view of the improved modulated metasurface antenna 800. Like the basic modulated metasurface antenna, the improved modulated metasurface antenna comprises a surface wave transducer 801 and a surface wave propagation medium 802, which has a radiating surface. The surface wave propagation medium 802 may be as described hereinbefore, comprising a dielectric substrate of circular shape.

However, the surface wave transducer 801 of the improved modulated metasurface antenna is different from that of the basic modulated metasurface antenna. The improved modulated metasurface antenna comprises an array of two monopoles 803, 804. In this embodiment, the two monopoles 803, 804 are positioned on a horizontal axis, which is designated “x” in FIG. 8. The horizontal axis “x” is parallel to that of FIG. 6 and crosses a center point. FIG. 8 further indicates a vertical axis, which is designated “y”. The two monopoles 803, 804 may be placed at x=0.17λ, y=0 and x=−0.17λ, y=0, which implies that the two monopoles 803, 804 are spaced apart by a distance of 0.34λ, λ representing a wavelength of interest at which the improved modulated metasurface antenna may operate. The two monopoles 803, 804 may be electrically coupled so as to jointly receive an identical excitation signal.

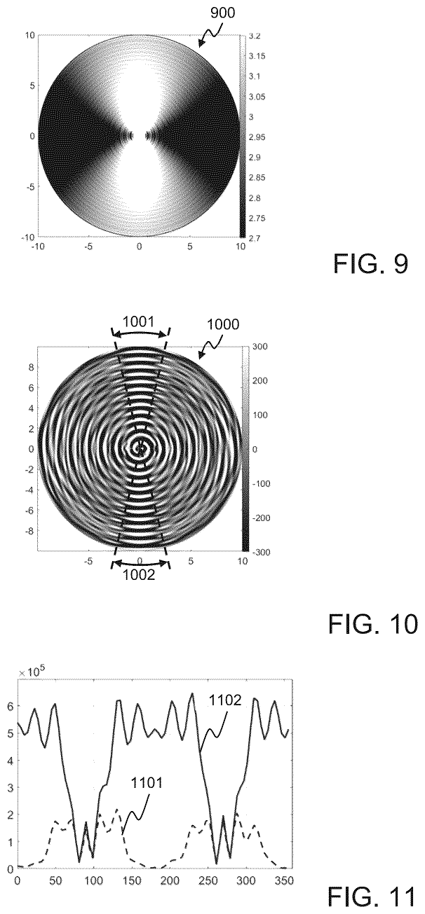

FIG. 9 schematically illustrates an azimuthal surface wave power distribution 900 of the surface wave transducer 103 in the improved modulated metasurface antenna. FIG. 9 is a graph that represents the radiating surface of the improved modulated metasurface antenna 800. The graph indicates a surface current density by means of gray levels. The lighter the gray level is at a point, the higher the surface current density is at that point. The surface current density results from a surface wave that is launched by the surface wave transducer 801 in response to an excitation signal. The surface current density is representative of the surface wave power density.

As can be seen from FIG. 9, the azimuthal surface wave power distribution 900 is non-uniform having the following characteristics with respect to the electromagnetic surface impedance distribution 600 illustrated in FIG. 6. A relatively large proportion of surface wave power is launched in the two azimuth ranges 601, 602 where the electromagnetic surface impedance variations are the largest. Conversely, a relatively small amount of surface wave power is launched in the two azimuth ranges where the electromagnetic surface impedance variations are relatively small. Consequently, compared with the basic modulated metasurface antenna, a significantly larger large proportion of the surface wave power that is launched will be leaked to produce radiation. Accordingly, a higher conversion efficiency can be achieved and, therefore, a higher overall efficiency.

However, in case the improved modulated metasurface antenna 800 has the electromagnetic surface impedance distribution illustrated in FIG. 6, this may result in a radiation pattern that is somewhat different from the flat top beam radiation pattern 500 illustrated in FIG. 5. This is because the electromagnetic surface impedance distribution illustrated in FIG. 6 has been designed for the basic modulated metasurface antenna of which the surface wave transducer provides an azimuthal surface wave power distribution that is uniform. In contrast, the surface wave transducer 801 of the improved modulated metasurface antenna provides the azimuthal surface wave power distribution 900 illustrated in FIG. 9, which is different, clearly non-uniform. This difference in azimuthal surface wave power distribution may require a redesign of the electromagnetic surface impedance distribution in order to obtain the flat top beam radiation pattern 500 with similar accuracy.

FIG. 10 schematically illustrates a redesigned electromagnetic surface impedance distribution 1000 for the improved modulated metasurface antenna 800 having the flat top beam radiation pattern 500. The redesigned electromagnetic surface impedance distribution 1000 is represented in a graph similar to that of FIG. 6. The remarks hereinbefore concerning the graph of FIG. 6 also apply to the graph of FIG. 10. Thus, the latter graph also indicates the electromagnetic surface impedance distribution 1000 by means of gray levels.

The redesigned electromagnetic surface impedance distribution 1000 illustrated in FIG. 10 is only slightly different from the electromagnetic surface impedance distribution 600 illustrated in FIG. 6. The redesigned electromagnetic surface impedance distribution 1000 also exhibits relatively large variations in two relatively narrow azimuth ranges 1001, 1002 which are substantially oriented along the vertical axis. Conversely, electromagnetic surface impedance variations are relatively small in two other azimuth ranges, which are relatively wide and substantially oriented along the horizontal axis. The non-uniform azimuthal surface wave power distribution 900 illustrated in FIG. 9 thus equally suits the redesigned electromagnetic surface impedance distribution 1000 illustrated in FIG. 10.

FIG. 11 schematically illustrates an azimuthal distribution of surface wave power arriving at a rim of the surface wave propagation medium in the improved modulated metasurface antenna 800 having the flat top beam radiation pattern 500. FIG. 11 is a graph similar to the graph of FIG. 7. The graph comprises two curves 1101, 1102. A first curve 1101 represents the azimuthal distribution of surface wave power arriving at the rim in the improved modulated metasurface antenna 800. A second curve 1102 represents the azimuthal distribution of surface wave power arriving at a rim in the basic modulated metasurface antenna. Accordingly, the second curve 1102 corresponds with the curve 701 in the graph of FIG. 7.

As can be seen from FIG. 11, a significantly smaller proportion of surface wave power arrives at the rim in the improved modulated metasurface antenna 800 than in the basic modulated metasurface antenna. This implies that significantly more surface wave power has leaked to produce radiation in the improved modulated metasurface antenna 800 than in the basic modulated metasurface antenna. Moreover, in the improved modulated metasurface antenna 800, undesired reflection and diffraction at the rim will be significantly less than in the basic modulated metasurface antenna. Consequently, the improved modulated metasurface antenna 800 has a significantly higher conversion efficiency than the basic modulated metasurface antenna. Given that the improved modulated metasurface antenna 800 and the basic modulated metasurface antenna have a comparable aperture efficiency, the overall efficiency of the improved modulated metasurface antenna 800 is significantly higher than that of the basic modulated metasurface antenna.

The flat top beam radiation pattern 500 is merely an example among numerous other radiation patterns for modulated metasurface antennas where a significant efficiency increase may be obtained. As discussed hereinbefore, any arbitrary desired radiation pattern may be translated into a particular electromagnetic surface impedance distribution. A relatively high conversion efficiency can be obtained by designing a surface wave transducer so that a greatest amount of surface wave power is launched in azimuth ranges where the electromagnetic surface impedance variations are largest. For the sake of comprehensiveness, another example is provided that concerns a conical sectorial beam radiation pattern.

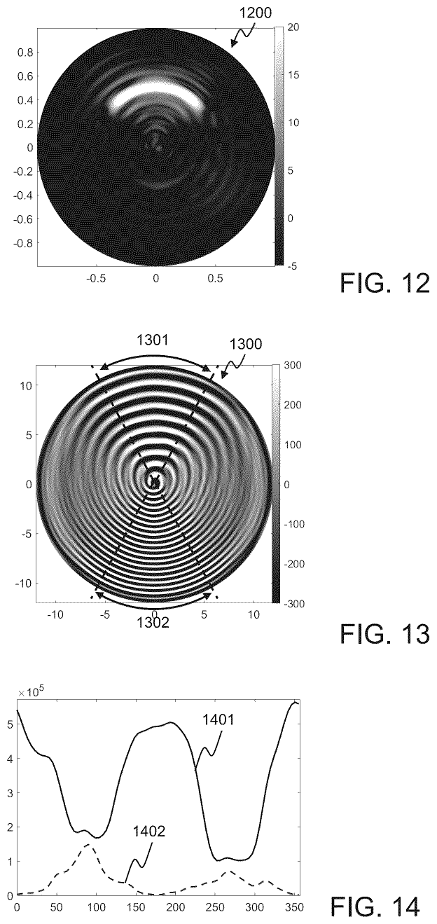

FIG. 12 schematically illustrates a conical sectorial beam radiation pattern 1200 produced by a modulated metasurface antenna. FIG. 12 is a graph similar to that of FIG. 5. The graph indicates a radiated power distribution in the plane by means of gray levels. The lighter the gray level is at a point, the higher the power density that is radiated at that point.

FIG. 13 schematically illustrates an electromagnetic surface impedance distribution 1300 for a basic modulated metasurface antenna having the conical sectorial beam radiation pattern 1200. FIG. 13 is a graph similar to that of FIG. 6. Like in the previous example concerning the flat top beam radiation pattern 500, in the basic modulated metasurface antenna, a monopole formed by a pin constitutes the surface wave transducer. Accordingly, the surface wave transducer has an azimuthal surface wave power distribution that is uniform. Surface wave power is isotropically launched into the surface wave propagation medium.

The electromagnetic surface impedance distribution 1300 illustrated in FIG. 13 is non-uniform in azimuth direction on the surface wave propagation medium. The electromagnetic surface impedance distribution 1300 exhibits relatively large variations in two relatively narrow azimuth ranges 1301, 1302. These two azimuth ranges 1301, 1302 in which relatively large electromagnetic surface impedance variations occur are substantially oriented along the vertical axis. Conversely, electromagnetic surface impedance variations are relatively small in two other, remaining azimuth ranges, which are relatively wide and substantially oriented along the horizontal axis.

FIG. 14 schematically illustrates an azimuthal distribution of surface wave power arriving at a rim of the surface wave propagation medium 104. FIG. 14 is a graph similar to that of FIG. 11. The graph comprises two curves 1401, 1402. A first curve 1401 represents the azimuthal distribution of surface wave power arriving at the rim in the basic modulated metasurface antenna having the sectorial conical beam radiation pattern 1200. A second curve 1402 represents the azimuthal distribution of surface wave power arriving at a rim in an improved modulated metasurface antenna having the sectorial conical beam radiation pattern.

The first curve 1401 in the graph of FIG. 14 shows that, in the basic modulated metasurface antenna, a relatively large proportion of surface wave power arrives at the rim over a relatively wide range of angles. This was also the case in the example concerning the flat top beam radiation pattern 500. Here too, all this surface wave power arriving at the rim has not been leaked to produce radiation. Moreover, undesired reflection and diffraction of surface wave power will occur at the rim. As a result, the basic modulated metasurface antenna having the sectorial conical beam radiation pattern will have relatively poor conversion efficiency and, therefore, relatively poor overall efficiency.

The improved modulated metasurface antenna may be similar to that 800 illustrated in FIG. 8 discussed hereinbefore. That is, the improved modulated metasurface antenna may have a surface wave transducer that comprises an array of two monopoles, which are positioned on the horizontal axis as illustrated in FIG. 8. In this embodiment, which concerns the conical sectorial beam radiation pattern 1200, the two monopoles may be differently placed at x=0.19λ, y=0 and x=−0.19λ, y=0, which implies that the two monopoles are spaced apart by a distance of 0.38λ. Accordingly, a non-uniform azimuthal surface wave power distribution is obtained, which is optimized with respect to an electromagnetic surface impedance distribution that causes the improved modulated metasurface antenna to produce the sectorial conical beam radiation pattern 1200. This electromagnetic surface impedance distribution may be slightly different from that 1300 illustrated in FIG. 13. As explained hereinbefore, a change in the azimuthal surface wave power distribution of the surface wave transducer entails a change in the electromagnetic surface impedance distribution for a given desired radiation pattern with a given aperture efficiency.

As can be seen from FIG. 14, a significantly smaller proportion of surface wave power arrives at the rim in the improved modulated metasurface antenna than in the basic modulated metasurface antenna. Thus, a significant efficiency improvement is also obtained in the case of the sectorial conical beam radiation pattern 1200, as in the case of the flat top beam radiation pattern 500, which was discussed hereinbefore with reference to FIG. 11.

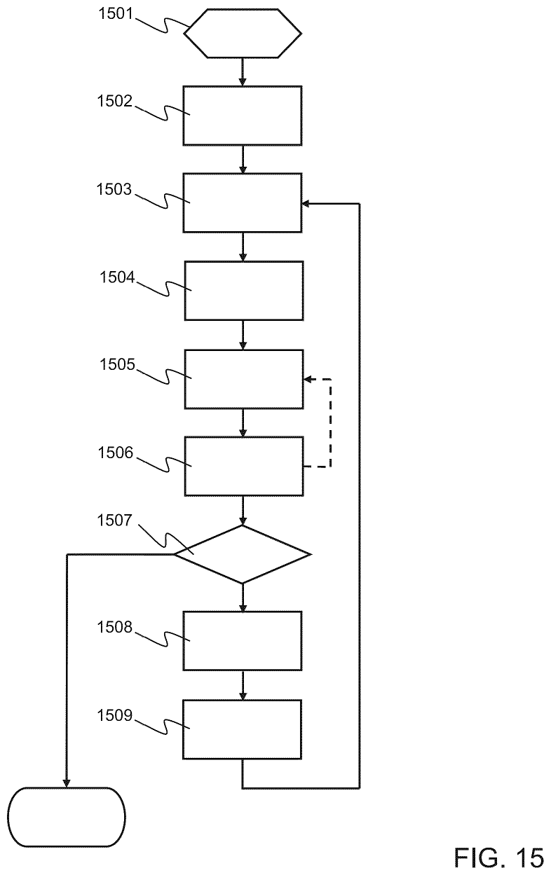

FIG. 15 schematically illustrates a method 1500 of designing a modulated metasurface antenna. FIG. 15 provides a schematic flow chart diagram of this method 1500, which comprises several steps 1501-1509. As discussed hereinbefore, the modulated metasurface antenna comprises a surface wave transducer and a surface wave propagation medium that has a radiating surface.

In a radiation pattern definition step 1501, a desired radiation pattern is defined for the modulated metasurface antenna. The desired radiation pattern may typically be defined in an elevation direction and an azimuth direction. The desired radiation pattern method may, in principle, be of any arbitrary shape. Whatever the shape is, the method described here with reference to FIG. 15 allows achieving a relatively high conversion efficiency and, therefore, a relatively high overall efficiency of the modulated metasurface antenna.

In an initial design step 1502, an initial embodiment of the surface wave transducer is defined that launches a surface wave according to a certain azimuthal surface wave power distribution. The initial embodiment of the surface wave transducer may be, for example, a single monopole formed by, for example, a pin. Accordingly, in that case, the azimuthal surface wave power distribution will be uniform. In addition, an embodiment for the surface wave propagation medium may be defined, which may have a given average electromagnetic surface impedance.

In a power computation step 1503, a computation is made of surface wave power that is launched into the surface wave propagation medium by the surface wave transducer. This computation may be based on the assumption that the surface wave propagation medium has a homogeneous electromagnetic surface impedance that is equal to the given average electromagnetic surface impedance. The computation based on this assumption may be made, for example, using a technique described in the article by M. Bodehou et al. entitled “Power balance and efficiency of metasurface antennas,” published in Scientific Reports, Nature Publishing Group, 2020, Vol. 10 (1), pp. 17508. vol. 10, 2020. This article will be referred to hereinafter as second-cited article for the sake of convenience.

In a surface current computation step 1504, the desired radiation pattern is scaled so that there is a match with the surface wave power that is launched into the surface wave propagation medium. A Green's function may then be used to compute a corresponding current on the radiating surface of the surface wave propagation medium.

In an impedance distribution elaboration step 1505, an electromagnetic surface impedance distribution is elaborated on the basis of the corresponding current on the radiating surface that has been computed. This impedance distribution elaboration may be based on a technique described in the first-cited article, which was cited hereinbefore as background art. As indicated, the technique described therein relies on an entire-domain discretization of the electric field integral equation (EFIE). The electromagnetic surface impedance distribution that is elaborated

In a performance assessment step 1506, a radiation pattern of the modulated metasurface antenna is determined, whereby the surface wave propagation medium has the electromagnetic surface impedance distribution elaborated in the preceding step. The radiation pattern may be determined by means of specific simulation software. A verification is made that the radiation pattern is sufficiently close to the desired radiation pattern. This corresponds with assessing the aperture efficiency. In addition, the conversion efficiency is assessed. The conversion efficiency may be assessed, for example, using a technique described in the second-cited article.

The impedance distribution elaboration step 1505 and the performance assessment step 1506 may be carried out repetitively. This may form an iterative process aiming at bringing the conversion efficiency to a higher level while achieving that the radiation pattern is sufficiently close to the desired radiation pattern. The latter corresponds with monitoring that the aperture efficiency is at a sufficiently high level. At the end of this iterative process, an electromagnetic surface impedance distribution is obtained that provides the highest possible conversion efficiency.

In a design evaluation step 1507, an assessment is made of whether the highest possible conversion efficiency that has been obtained with the embodiment of the surface wave transducer is satisfactory, or not. If the assessment is positive, the design may be considered to be completed. If the assessment is negative, the design may continue with the following steps, which are described hereinafter.

In a rim power distribution computation step 1508, a computation is made of an azimuthal distribution of surface wave energy arriving on a rim of the surface wave propagation medium. This computation applies to the embodiment of the surface wave transducer for which the steps described hereinbefore have been carried out. The computation may further apply to the electromagnetic surface impedance distribution that provides the highest possible conversion efficiency. The computation may result in a graph similar to that illustrated in FIGS. 7 and 14.

In a surface wave transducer redesign step 1509, a new embodiment of the surface wave transducer is designed based on the azimuthal distribution of surface wave energy arriving on the rim of the surface wave propagation medium that has been computed. The new embodiment may be designed so that the surface wave transducer provides a non-uniform azimuthal surface wave power distribution that is inversely proportional to the azimuthal distribution of surface wave energy arriving on the rim, at least approximately. The surface wave transducer redesign step thus aims at obtaining a more uniformly azimuthal distribution of surface wave power arriving on the rim of the surface wave propagation medium. This allows achieving a higher conversion efficiency.

The new embodiment of the surface wave transducer may be designed using antenna array theory. For example, the new embodiment of the surface wave transducer may comprise an array of two monopoles as illustrated in FIG. 8. Alternatively, the new embodiment may comprise an array of a larger number of monopoles or other surface wave launching structures.

Once the new embodiment of the surface wave transducer has been designed, the power computation step 1503 described hereinbefore may be carried out anew. The latter step is then followed by the surface current computation step 1504, the impedance distribution elaboration step 1505, and the performance assessment step 1506. The latter two steps may be carried out repetitively forming the iterative process described hereinbefore. The design evaluation step 1507, may also be carried out anew, which implies a further possible redesign of the surface wave transducer in case the highest possible conversion efficiency that has been obtained is still not satisfactory.

FIG. 16 illustrates an antenna-based system 1600 comprising a modulated metasurface antenna 1601. FIG. 16 provides a schematic block diagram of the antenna-based system 1600. The modulated metasurface antenna 1601 may be, for example, the improved modulated metasurface antenna 800 illustrated in FIG. 8, or another embodiment. The antenna-based system 1600 further comprises a radio frequency device 1602, which may operate in a transmission mode or in a reception mode, or in both these modes. The radio frequency device 1602 may thus comprise an emitter device 1603 that applies a radio-frequency excitation signal to a surface wave transducer of the modulated metasurface antenna. In an embodiment in which the surface wave transducer comprises an array of surface wave transducing elements, the emitter device 1603 may apply the radio-frequency excitation signal in the form of a set of signal components having a phase relationship and an amplitude relationship with respect to each other. The surface wave transducer may then provide a non-uniform azimuthal surface wave power distribution that depends on the phase relationship and the amplitude relationship between the signal components.

The embodiments described hereinbefore with reference to the drawings are presented by way of illustration. The invention may be implemented in numerous different ways. In order to illustrate this, some alternatives are briefly indicated.

The invention may be applied in numerous types of products or methods related to modulated metasurface antennas. The embodiments presented hereinbefore relate to operation in a transmission mode for the sake of explanation. However, a modulated metasurface antenna in accordance with the invention may equally be used in a receiving mode. In a wording different from that of the claims, for both modes the following may hold. The electromagnetic surface impedance distribution is non-uniform in azimuthal direction on the surface wave propagation medium so that there are azimuthal ranges in which the impedance variations are largest from the surface wave transducer to the rim of the surface wave propagation medium. The surface wave transducer launches surface wave power non-uniformly in azimuth direction so that a greatest amount of surface wave power is launched in the azimuthal ranges where the impedance variations are the largest.

There are numerous different ways of implementing a modulated metasurface antenna in accordance with the invention. For example, the surface wave transducer need not have a central location. The surface wave transducer may be off-centered, which may even be advantageous in certain embodiments and for certain desired radiation patterns. Since a modulated metasurface antenna in accordance with the invention has a non-uniform azimuthal surface wave power distribution, impedance variations in azimuth ranges that receive relatively little surface wave power are of no particular concern. Consequently, the impedance variations in these ranges may be relatively large or relatively small.

There are numerous different ways of implementing a surface wave transducer in a modulated metasurface antenna in accordance with the invention. In the embodiments presented hereinbefore, a suitable azimuthal surface wave power distribution is obtained with an array of two monopoles. In other embodiments, a suitable azimuthal surface wave power distribution may be obtained with an array comprising a larger number of elements, which need not necessarily be in the form of monopoles. In yet other embodiments, the surface wave transducer may comprise one or more elements that, taken in isolation, already provide a non-uniform azimuthal surface wave power distribution. In yet other embodiments, the surface wave transducer may be arranged to provide various azimuthal surface wave power distributions from which a suitable one may be selected. To that end, the surface wave transducer may comprise several elements and several switches that can be controlled so that these elements may form various configurations. In yet other embodiments, an azimuthal surface wave power distribution may be controlled, and thus adjusted, by changing a phase relationship or an amplitude relationship, or both, between respective signals applied to respective elements of the surface wave transducer.

There are numerous different ways of implementing a surface wave propagation medium in accordance with the invention. In the embodiments presented hereinbefore, the surface wave propagation medium comprises a dielectric substrate having a side provided with multitude of electrically conductive patches. In other embodiments, other forms of electrically conductive elements may be used to obtain a certain electromagnetic surface impedance distribution. In yet other embodiments, the surface wave propagation medium may not comprise a dielectric substrate. For example, the surface wave propagation medium may comprise a multitude of sub-wavelength sized electrically conductive elements placed on a ground plane. These elements may be in the form of metal cylinders with elliptical cross section, which are arranged in a lattice structure. The ground plane may also be of metal and have a stepped shape providing vertical offsets between metal cylinders. Such a metal-only embodiment may withstand harsh environments.

In general, there are numerous different ways of implementing the invention, whereby different implementations may have different topologies. In any given topology, a single entity may carry out several functions, or several entities may jointly carry out a single function. In this respect, the drawings are very diagrammatic.

The remarks made hereinbefore demonstrate that the embodiments described with reference to the drawings illustrate the invention, rather than limit the invention. The invention can be implemented in numerous alternative ways that are within the scope of the appended claims. All changes that come within the meaning and range of equivalency of the claims are to be embraced within their scope. Any reference sign in a claim should not be construed as limiting the claim. The verb “comprise” in a claim does not exclude the presence of other elements or other steps than those listed in the claim. The same applies to similar verbs such as “include” and “contain”. The mention of an element in singular in a claim pertaining to a product, does not exclude that the product may comprise a plurality of such elements. Likewise, the mention of a step in singular in a claim pertaining to a method does not exclude that the method may comprise a plurality of such steps. The mere fact that respective dependent claims define respective additional features, does not exclude combinations of additional features other than those reflected in the claims.

1. A modulated metasurface antenna comprising a surface wave transducer and a surface wave propagation medium, the surface wave transducer being adapted to generate a surface wave when a radio-frequency excitation signal is applied to the surface wave transducer, whereby the surface wave propagates throughout the surface wave propagation medium from the surface wave transducer to a rim of the surface wave propagation medium, the surface wave propagation medium having an electromagnetic surface impedance distribution that exhibits impedance variations that extend from the surface wave transducer to the rim of the surface wave propagation medium, the electromagnetic surface impedance distribution being non-uniform in azimuth direction on the surface wave propagation medium so that there are azimuth ranges in which the impedance variations are smallest from the surface wave transducer to the rim of the surface wave propagation medium,
wherein the surface wave transducer has a non-uniform azimuthal surface wave power distribution so that, compared to a uniform azimuthal surface wave power distribution, a smaller amount of surface wave power is launched in the azimuth ranges where the impedance variations are the smallest.

2. A modulated metasurface antenna according to claim 1, wherein the surface wave transducer comprises an array of surface wave transducing elements, whereby any two closest adjacent surface wave transducing elements are separated from each other by a distance less than an operating wavelength of the modulated metasurface antenna.

3. A modulated metasurface antenna according to claim 2, whereby any two closest adjacent surface wave transducing elements are separated from each other by a distance comprised between 0.1 and 0.8 times the operating wavelength.

4. A modulated metasurface antenna according to claim 3, whereby any two closest adjacent surface wave transducing elements are separated from each other by a distance comprised between 0.2 and 0.5 times the operating wavelength.

5. A modulated metasurface antenna according to claim 1, wherein the surface wave transducer is adapted to provide different azimuthal surface wave power distributions, the non-uniform azimuthal surface wave power distribution being a selected one of the different azimuthal surface wave power distributions.

6. A modulated metasurface antenna according to claim 1, the modulated metasurface antenna having a flat top beam radiation pattern.

7. A modulated metasurface antenna according to claim 1, the modulated metasurface antenna having a sectorial conical beam radiation pattern.

8. A modulated metasurface antenna according to claim 1, the surface wave propagation medium comprising a support provided with a ground plane and a multitude of sub-wavelength-sized conductive elements, which at least partially define the electromagnetic surface impedance distribution.

9. A modulated metasurface antenna according to claim 1, wherein the surface wave transducer comprises at least one of the following surface wave transducing elements: a monopole, a slot and a waveguide.

10. An antenna-based system comprising a modulated metasurface antenna according to claim 1.

11. An antenna-based system according to claim 10, comprising an emitter device adapted to apply the radio-frequency excitation signal to the surface wave transducer of the modulated metasurface antenna.

12. An antenna-based system according to claim 11, wherein the surface wave transducer comprises an array of surface wave transducing elements, the emitter device being arranged to apply the radio-frequency excitation signal in the form of a set of signal components having a phase relationship and an amplitude relationship with respect to each other so that the surface wave transducer provides an azimuthal surface wave power distribution that depends on the phase relationship and the amplitude relationship between the signal components.

13. A method of designing a modulated metasurface antenna according to claim 1, the method comprising:
elaborating an initial electromagnetic surface impedance distribution for the surface wave propagation medium that causes the modulated metasurface antenna to have a desired radiation pattern, on the basis of an initial surface wave transducer that launches a surface wave according to an initial azimuthal surface wave power distribution;
determining an azimuthal distribution of surface wave power arriving on the rim of the surface wave propagation medium; and
adapting the surface wave transducer on the basis of the azimuthal distribution of surface wave power arriving on the rim of the surface wave propagation medium, so as to obtain a more uniformly azimuthal distribution of surface wave power arriving on the rim of the surface wave propagation medium thereby increasing conversion efficiency of the modulated metasurface antenna.

14. A method of designing according to claim 13, wherein the initial azimuthal surface wave power distribution of the initial surface wave transducer is uniform.
